(19) United States
(12) Patent Application Publication
(10) Pub. No.: US 2026/0134843 A1
(43) Pub. Date: May 14, 2026

(54) DISPLAY APPARATUS AND METHOD FOR CONTROLLING THE SAME

(71) Applicant: SAMSUNG ELECTRONICS CO., LTD., Suwon-si (KR)

(72) Inventors: Seungyong SHIN, Suwon-si (KR); Jungmo KANG, Suwon-si (KR); Myungjoon KIM, Suwon-si (KR); Sujin KIM, Suwon-si (KR); Hyungjin KIM, Suwon-si (KR)

(73) Assignee: SAMSUNG ELECTRONICS CO., LTD., Suwon-si (KR)

(21) Appl. No.: 19/343,358

(22) Filed: Sep. 29, 2025

Related U.S. Application Data
(63) Continuation of application No. PCT/KR2025/014335, filed on Sep. 15, 2025.

(30) Foreign Application Priority Data
Nov. 13, 2024 (KR) 10-2024-0161498

(51) Int. Cl. G09G 3/34; G09G 3/00

(52) U.S. Cl. CPC G09G 3/3413; G09G 3/006; G09G 3/3426; G09G 2320/045; G09G 2320/0646; G09G 2330/12; G09G 2360/127; G09G 2360/16

(57) ABSTRACT

A display apparatus includes: a light emitter; and a controller including memory storing instructions and at least one processor configured to execute the instructions, wherein the instructions, when executed by the at least one processor individually or collectively, cause the display apparatus to: in a first image frame, control a driving current applied to the light emitter based on first image frame data corresponding to the first image frame, in the first image frame, receive a feedback voltage detected at a cathode of the light emitter, and in a second image frame following the first image frame, control the driving current based on second image frame data corresponding to the second image frame and a voltage difference between the feedback voltage and a reference voltage corresponding to the first image frame data.

This application is a by-pass continuation of International Application No. PCT/KR2025/014335, filed on Sep. 15, 2025, which is based on and claims priority to Korean Patent Application No. 10-2024-0161498, filed in the Korean Intellectual Property Office on Nov. 13, 2024, the disclosures of which are incorporated by reference herein in their entireties.

### BACKGROUND

### 1. Field

The disclosure relates to a display apparatus and a method for controlling the same, and more particularly, to a display apparatus capable of compensating for deterioration of a plurality of light-emitting devices and a method for controlling the display apparatus.

### 2. Description of Related Art

In general, display apparatuses are a type of output device for visually displaying obtained or stored image information to a user, and are used in various fields such as the home or workplace.

A display apparatus includes a backlight unit (BLU) that provides light to a liquid crystal panel, and the BLU includes a plurality of light-emitting devices that may independently emit light. The light-emitting device includes, for example, a light-emitting diode (LED) or an organic light-emitting diode (OLED).

Depending on the type, a display apparatus may include a display panel that displays an image without a BLU. The display panel includes a plurality of light-emitting devices that may independently emit light, and the plurality of light-emitting devices include a red LED, a green LED, and a blue LED.

Performance of the LED may be reduced by a deterioration phenomenon. Because red, green, and blue LEDs have different physical properties and materials, the degree of performance deterioration may vary.

### SUMMARY

Provided is a display apparatus that may compensate for performance reduction due to a deterioration phenomenon of a light-emitting diode (LED), and a method for controlling the display apparatus.

Further provided is a display apparatus that may compensate for performance reduction due to a deterioration phenomenon based on different criteria for each type of LED, and a method for controlling the display apparatus.

Further provided is a display apparatus that may rapidly recover performance of an LED by minimizing heat generated from the LED when the performance of the LED deteriorates, and a method for controlling the display apparatus.

Technical aspects that can be achieved by the disclosure are not limited to the above-mentioned aspects, and other technical aspects not mentioned will be clearly understood by one of ordinary skill in the technical art to which the disclosure belongs from the following description.

According to an aspect of the disclosure, a display apparatus includes: a light emitter; and a controller including memory storing instructions and at least one processor configured to execute the instructions, wherein the instructions, when executed by the at least one processor individually or collectively, cause the display apparatus to: in a first image frame, control a driving current applied to the light emitter based on first image frame data corresponding to the first image frame, in the first image frame, receive a feedback voltage detected at a cathode of the light emitter, and in a second image frame following the first image frame, control the driving current based on second image frame data corresponding to the second image frame and a voltage difference between the feedback voltage and a reference voltage corresponding to the first image frame data.

The instructions, when executed by the at least one processor individually or collectively, may further cause the display apparatus to, in the second image frame, cause the driving current to have a second amplitude greater than a first amplitude corresponding to the second image frame data, based on the feedback voltage being greater than the reference voltage.

The instructions, when executed by the at least one processor individually or collectively, may further cause the display apparatus to identify the second amplitude based on the voltage difference.

The instructions, when executed by the at least one processor individually or collectively, may further cause the display apparatus to, in the second image frame, apply the driving current to the light emitter for a second application time shorter than a first application time corresponding to the second image frame data, based on the feedback voltage being greater than the reference voltage.

A product of the second amplitude and the second application time may be greater than a product of the first amplitude and the first application time.

The instructions, when executed by the at least one processor individually or collectively, may further cause the display apparatus to, in the second image frame, cause the driving current to have the first amplitude for the first application time, based on the feedback voltage being equal to the reference voltage.

The instructions, when executed by the at least one processor individually or collectively, may further cause the display apparatus to, in the second image frame, increase a driving current applied to an anode of the light emitter, based on the feedback voltage being less than the reference voltage.

The light emitter may include a red light-emitting diode (LED) configured to output red light, a green LED configured to output green light, and a blue LED configured to output blue light, the first image frame data may include an R value which is a color value of the red LED, a G value which is a color value of the green LED, and a B value which is a color value of the blue LED, and the reference voltage corresponding to the first image frame data may include a first reference voltage corresponding to the R value, a second reference voltage corresponding to the G value, and a third reference voltage corresponding to the B value.

Based on the R value being equal to the B value, a magnitude of the first reference voltage may be greater than a magnitude of the third reference voltage.

Based on the R value being equal to the G value, a magnitude of the second reference voltage may be greater than a magnitude of the first reference voltage.

According to an aspect of the disclosure, a method of controlling a display apparatus includes: in a first image frame, controlling a driving current applied to a light emitter of the display apparatus based on first image frame data corresponding to the first image frame; in the first image frame, receiving a feedback voltage detected at a cathode of the light emitter; and in a second image frame following the first image frame, controlling the driving current based on second image frame data corresponding to the second image frame and a voltage difference between the feedback voltage and a reference voltage corresponding to the first image frame data.

The controlling the driving current based on the second image frame data and the voltage difference may include causing the driving current to have a second amplitude greater than a first amplitude corresponding to the second image frame data, based on the feedback voltage being greater than the reference voltage.

The method may further include: identifying the second amplitude based on the voltage difference.

The controlling the driving current based on the second image frame data and the voltage difference further may include applying the driving current to the light emitter for a second application time shorter than a first application time corresponding to the second image frame data, based on the feedback voltage being greater than the reference voltage.

A product of the second amplitude and the second application time may be greater than a product of the first amplitude and the first application time.

According to an aspect of the disclosure, a non-transitory computer readable medium has instructions stored therein, which when executed by at least one processor cause the at least one processor to execute a method of controlling a display apparatus, the method including: in a first image frame, controlling a driving current applied to a light emitter of the display apparatus based on first image frame data corresponding to the first image frame; in the first image frame, receiving a feedback voltage detected at a cathode of the light emitter; and in a second image frame following the first image frame, controlling the driving current based on second image frame data corresponding to the second image frame and a voltage difference between the feedback voltage and a reference voltage corresponding to the first image frame data.

With regard to the method executed based on the instructions stored in the non-transitory computer readable medium, the controlling the driving current based on the second image frame data and the voltage difference may include causing the driving current to have a second amplitude greater than a first amplitude corresponding to the second image frame data, based on the feedback voltage being greater than the reference voltage.

With regard to the method executed based on the instructions stored in the non-transitory computer readable medium, the method may further include: identifying the second amplitude based on the voltage difference.

With regard to the method executed based on the instructions stored in the non-transitory computer readable medium, the controlling the driving current based on the second image frame data and the voltage difference further may include applying the driving current to the light emitter for a second application time shorter than a first application time corresponding to the second image frame data, based on the feedback voltage being greater than the reference voltage.

With regard to the method executed based on the instructions stored in the non-transitory computer readable medium, a product of the second amplitude and the second application time is greater than a product of the first amplitude and the first application time.

### BRIEF DESCRIPTION OF THE DRAWINGS

The above and other aspects and features of certain embodiments of the present disclosure will be more apparent from the following description taken in conjunction with the accompanying drawings, in which:

FIG. 1 illustrates an example of an appearance of a display apparatus according to one or more embodiments;

FIG. 2 illustrates an example of a configuration of a display apparatus according to one or more embodiments;

FIG. 3 illustrates an example of a liquid crystal panel included in a display apparatus according to one or more embodiments;

FIG. 4 illustrates an example of a backlight unit (BLU) included in a display apparatus according to one or more embodiments;

FIG. 5 is a diagram illustrating that a plurality of light-emitting diodes (LEDs) of a BLU are divided into dimming blocks according to one or more embodiments;

FIG. 6 is a control block diagram of a display apparatus according to one or more embodiments;

FIG. 7 illustrates an example in which a display apparatus converts image data into dimming data according to one or more embodiments;

FIG. 8 illustrates an example of a light-emitting device included in a BLU according to one or more embodiments;

FIG. 9 illustrates a configuration for controlling a driving current flowing through a light-emitting device according to one or more embodiments;

FIG. 10 is a flowchart illustrating an example method for controlling a display apparatus according to one or more embodiments;

FIG. 11 illustrates reference voltages that vary for each type of LED and RGB color value according to one or more embodiments;

FIG. 12 illustrates a state in which LEDs are not deteriorated according to one or more embodiments;

FIG. 13 illustrates a state in which a portion of LEDs are deteriorated according to one or more embodiments;

FIG. 14 illustrates an example of a driving current applied to an LED based on the same color value, when the LED is deteriorated and when the LED is not deteriorated according to one or more embodiments; and

FIG. 15 illustrates a state in which a driving voltage applied to LEDs is insufficient according to one or more embodiments.

### DETAILED DESCRIPTION

One or more embodiments disclosed herein, and the terms used herein to describe said one or more embodiments, are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

It will be understood that if a certain component is referred to as being “coupled with,” “coupled to,” “supported on” or “in contact with” another component, it means that the component may be coupled with the other component directly or indirectly via a third component.

It will also be understood that when an element is referred to as being “on” another element, it may be directly on the other element or intervening elements may also be present.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

Hereinafter, one or more embodiments of the disclosure will be described in detail with reference to the accompanying drawings.

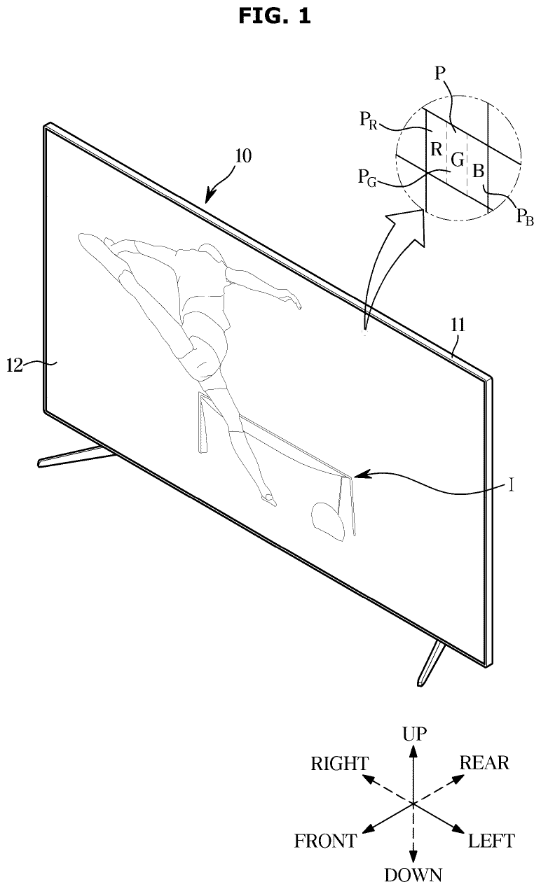

FIG. 1 illustrates an example of an appearance of a display apparatus according to one or more embodiments.

Referring to FIG. 1, a display apparatus 10 is a device capable of processing an image signal received from the outside and visually displaying a processed image. Hereinafter, a case in which the display apparatus 10 is a television (TV) is exemplified, but is not limited thereto. For example, the display apparatus 10 may be implemented in various forms, such as a monitor, a portable multimedia device, a portable communication device, and the like, and the form of the display apparatus 10 is not limited as long as it is a device that visually displays an image.

In addition, the display apparatus 10 may be a large format display (LFD) installed outdoors, such as a building rooftop or a bus stop. Here, the outdoors is not necessarily limited to an outdoor space, and the display apparatus 10 according to one or more embodiments may be installed wherever a large number of people may come and go, even indoors such as at subway stations, shopping malls, movie theaters, office buildings, and stores.

The display apparatus 10 may receive content including a video signal and an audio signal from various content sources, and output video and audio corresponding to the video signal and the audio signal, respectively. For example, the display apparatus 10 may receive content data through a broadcast reception antenna or a wired cable, receive content data from a content playback apparatus, or receive content data from a content-providing server of a content provider.

As shown in FIG. 1, the display apparatus 10 may include a main body 11 and a screen 12 for displaying an image I.

The main body 11 forms an exterior of the display apparatus 10, and components for the display apparatus 10 to display the image I or perform various functions may be provided inside the main body 11. The main body 11 shown in FIG. 1 has a flat plate shape, but the shape of the main body 11 is not limited to that shown in FIG. 1. For example, the main body 11 may have a curved plate shape.

The screen 12 is formed on a front surface of the main body 11, and may display the image I. For example, the screen 12 may display a still image or a video. In addition, the screen 12 may display a two-dimensional plane image or a three-dimensional stereoscopic image using binocular parallax of a user.

The screen 12 may include a liquid crystal panel capable of transmitting or blocking light emitted by a backlight unit (BLU), or the like.

A plurality of pixels P may be formed on the screen 12, and the image I displayed on the screen 12 may be formed by light emitted from each of the plurality of pixels P. For example, the image I may be formed on the screen 12 by combining light emitted from each of the plurality of pixels P like a mosaic.

Each of the plurality of pixels P may emit light of various brightness and various colors. In order to emit light of various colors, each of the plurality of pixels P may include sub-pixels PR, PG, and PB.

The sub-pixels PR, PG, and PB may include a red sub-pixel PR capable of emitting red light, a green sub-pixel PG capable of emitting green light, and a blue sub-pixel PB capable of emitting blue light. For example, the red light may represent light having a wavelength of approximately 700 nm (nanometer, one billionth of a meter) to 800 nm. The green light may represent light having a wavelength of approximately 500 nm to 600 nm. The blue light may represent light having a wavelength of approximately 400 nm to 500 nm.

By combining the red light of the red sub-pixel PR, the green light of the green sub-pixel PG, and the blue light of the blue sub-pixel PB, light of various brightness and various colors may be emitted from each of the plurality of pixels P.

According to one or more embodiments, in a case where the display apparatus 10 is a self-emissive display apparatus, a backlight unit may include a red light-emitting diode (LED) that outputs red light, a green LED that outputs green light, and a blue LED that outputs blue light, and may be used as a display panel. According to one or more embodiments, in a case where the display apparatus 10 is a self-emissive display apparatus, the display apparatus 10 may not include a liquid crystal panel.

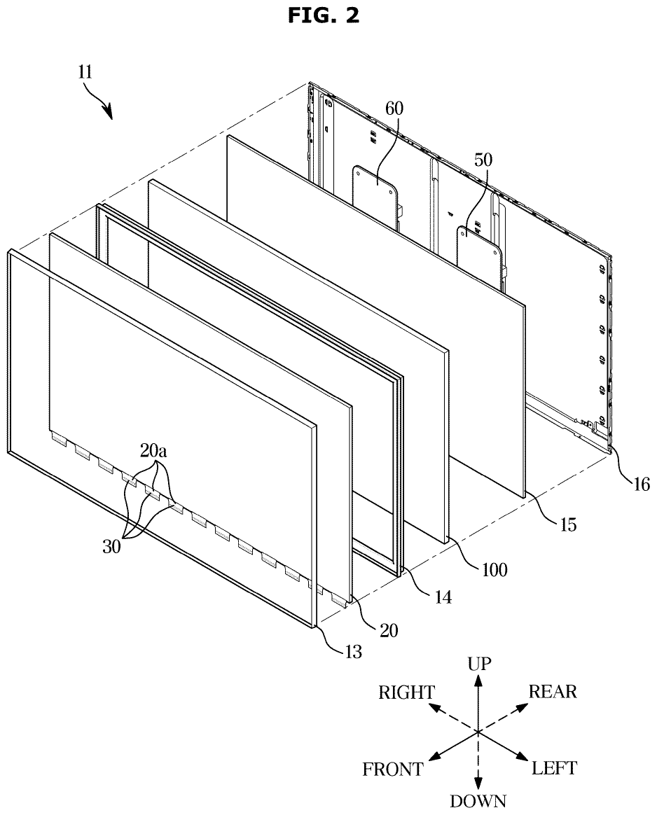

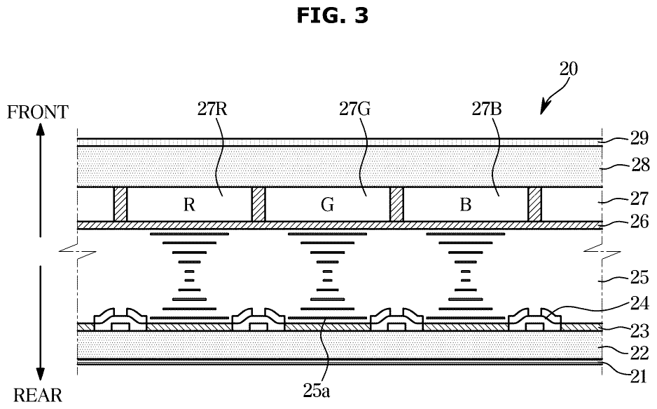

FIG. 2 illustrates an example of a configuration of a display apparatus according to one or more embodiments, and FIG. 3 illustrates an example of a liquid crystal panel included in a display apparatus according to one or more embodiments.

As shown in FIG. 2, various components for generating an image I on the screen 12 may be provided in the main body 11.

For example, the main body 11 may include a backlight unit (or light source apparatus) 100 which is a surface light source, a liquid crystal panel 20 blocking or transmitting light emitted from the backlight unit 100, a control assembly 50 controlling operations of the backlight unit 100 and the liquid crystal panel 20, and a power assembly 60 supplying power to the backlight unit 100 and the liquid crystal panel 20. In addition, the main body 11 may include a bezel 13, a frame middle mold 14, a bottom chassis 15, and a rear cover 16 for supporting the liquid crystal panel 20, the backlight unit 100, the control assembly 50, and the power assembly 60.

The backlight unit 100 may include a point light source that emits white light. In addition, the backlight unit 100 may refract, reflect, and scatter the light to convert the light emitted from the point light source into a uniform surface light. As described above, the backlight unit 100 may refract, reflect, and scatter the light emitted from the point light source to emit a uniform surface light in a forward direction.

The backlight unit 100 will be described in more detail below.

The liquid crystal panel 20 is provided in front of the backlight unit 100, and blocks or transmits light emitted from the backlight unit 100 to form the image I.

A front surface of the liquid crystal panel 20 forms the screen 12 of the display apparatus 10 described above, and the liquid crystal panel 20 may form the plurality of pixels P. The plurality of pixels P of the liquid crystal panel 20 may independently block or transmit the light of the backlight unit 100. In addition, the light transmitted by the plurality of pixels P may form the image I to be displayed on the screen 12.

For example, as shown in FIG. 3, the liquid crystal panel 20 may include a first polarizing film 21, a first transparent substrate 22, a pixel electrode 23, a thin film transistor 24, a liquid crystal layer 25, a common electrode 26, a color filter 27, a second transparent substrate 28, and a second polarizing film 29.

The first transparent substrate 22 and the second transparent substrate 28 may fixedly support the pixel electrode 23, the thin film transistor 24, the liquid crystal layer 25, the common electrode 26, and the color filter 27. The first and second transparent substrates 22 and 28 may be formed of tempered glass or transparent resin.

The first polarizing film 21 and the second polarizing film 29 are provided on outer sides of the first and second transparent substrates 22 and 28. The first polarizing film 21 and the second polarizing film 29 may each transmit specific polarized light and block (reflect or absorb) the other polarized light. For example, the first polarizing film 21 may transmit light polarized in a first direction and block (reflect or absorb) the other polarized light. In addition, the second polarizing film 29 may transmit light polarized in a second direction and block (reflect or absorb) the other polarized light. In this instance, the first direction and the second direction may be orthogonal to each other. Thus, the polarized light passing through the first polarizing film 21 may not directly pass through the second polarizing film 29.

The color filter 27 may be provided on an inner side of the second transparent substrate 28. The color filter 27 may include, for example, a red filter 27R transmitting red light, a green filter 27G transmitting green light, and a blue filter 27B transmitting blue light. In addition, the red filter 27R, the green filter 27G, and the blue filter 27B may be arranged side by side. A region occupied by the color filter 27 corresponds to the pixel P described above. A region occupied by the red filter 27R corresponds to the red sub-pixel PR, a region occupied by the green filter 27G corresponds to the green sub-pixel PG, and a region occupied by the blue filter 27B corresponds to the blue sub-pixel PB.

The pixel electrode 23 may be provided on an inner side of the first transparent substrate 22, and the common electrode 26 may be provided on the inner side of the second transparent substrate 28. The pixel electrode 23 and the common electrode 26 are formed of a metal material through which electricity is conducted, and may generate an electric field for changing the arrangement of liquid crystal molecules 25a constituting the liquid crystal layer 25 to be described below.

The thin film transistor (TFT) 24 is provided on the inner side of the second transparent substrate 22. The TFT 24 may be turned on (closed) or off (opened) by image data provided from a panel driver 30. In addition, by turning the TFT 24 on (closing) or off (opening), an electric field may be formed or removed from between the pixel electrode 23 and the common electrode 26.

The liquid crystal layer 25 is formed between the pixel electrode 23 and the common electrode 26 and is filled with liquid crystal molecules 25a. The liquid crystal may represent an intermediate state between a solid (crystal) and a liquid. The liquid crystal may exhibit optical properties depending on a change in electric field. For example, a direction of the molecular arrangement constituting the liquid crystal may change depending on a change in electric field. As a result, optical properties of the liquid crystal layer 25 may change according to the presence or absence of the electric field passing through the liquid crystal layer 25. For example, the liquid crystal layer 25 may rotate a polarization direction of light about an optical axis according to the presence or absence of the electric field. Accordingly, the polarized light that has passed through the first polarizing film 21 is changed in polarization direction while passing through the liquid crystal layer 25, and may pass through the second polarizing film 29.

At one edge of the liquid crystal panel 20, a cable 20a through which image data is transmitted to the liquid crystal panel 20 and a display driver integrated circuit (DDI) 30 (hereinafter, referred to as the “panel driver”) that processes digital image data and outputs an analog image signal are provided.

The cable 20a may electrically connect between the control assembly 50/the power assembly 60 and the panel driver 30, and may also electrically connect the panel driver 30 and the liquid crystal panel 20. The cable 20a may include a flexible flat cable or a film cable that may be bendable.

The panel driver 30 may receive image data and power from the control assembly 50/the power assembly 60 through the cable 20a. Further, the panel driver 30 may provide image data and driving current to the liquid crystal panel 20 through the cable 20a.

In addition, the cable 20a and the panel driver 30 may be integrally implemented as a film cable, a chip on film (COF), a tape carrier package (TCP), or the like. In other words, the panel driver 30 may be disposed on the cable 20a. However, the disclosure is not limited thereto, and the panel driver 30 may be disposed on the liquid crystal panel 20.

The control assembly 50 may include a control circuit that controls operations of the liquid crystal panel 20 and the backlight unit 100. For example, the control circuit may process a video signal and/or an audio signal received from an external content source. The control circuit may transmit the image data to the liquid crystal panel 20, and may transmit dimming data to the backlight unit 100.

The power assembly 60 may include a power circuit supplying power to the liquid crystal panel 20 and the backlight unit 100. The power circuit may supply power to the control assembly 50, the backlight unit 100, and the liquid crystal panel 20.

The control assembly 50 and the power assembly 60 may be implemented with a printed circuit board and various circuits mounted on the printed circuit board. For example, the power circuit may include a condenser, a coil, a resistance element, a processor, and the like and a power circuit board on which these elements are mounted. In addition, the control circuit may include a memory, a processor, and a control circuit board on which these elements are mounted.

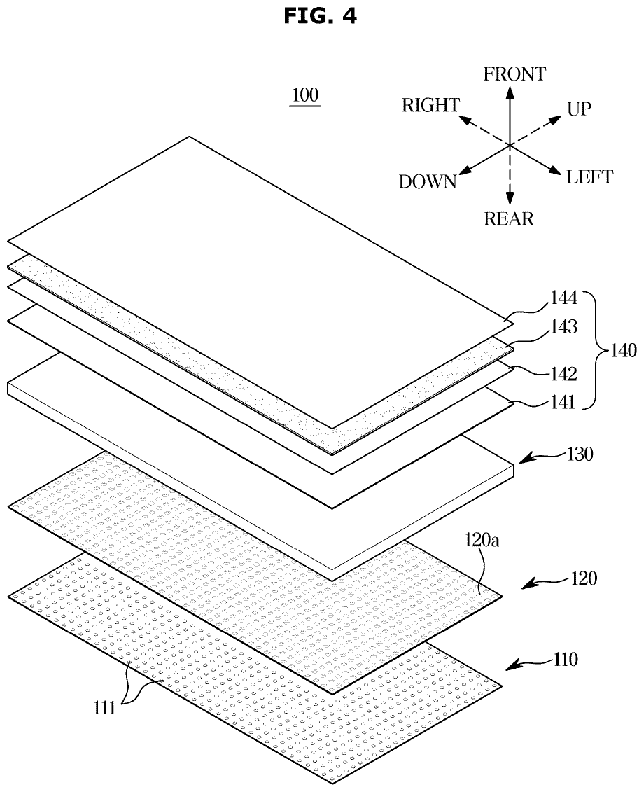

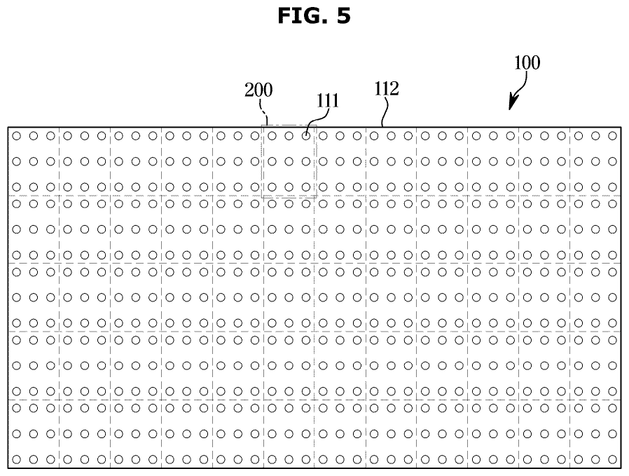

FIG. 4 illustrates an example of the backlight unit 100 included in the display apparatus 10, and FIG. 5 is a diagram illustrating that a plurality of LEDs of the backlight unit 100 are divided into dimming blocks according to one or more embodiments.

As shown in FIG. 4, the backlight unit 100 may include a light source module 110 generating light, a reflector sheet 120 reflecting light, a diffuser plate 130 uniformly diffusing light, and an optical sheet 140 improving luminance of the output light.

The light source module 110 may include a plurality of light emitters 111 emitting light, and a substrate 112 supporting/fixing the plurality of light emitters 111.

The plurality of light emitters 111 may be arranged in a predetermined pattern to allow light to be emitted with uniform luminance. The plurality of light emitters 111 may be arranged to allow a distance between a single light source and each light source adjacent thereto to be the same.

For example, as shown in FIG. 4, the plurality of light emitters 111 may be aligned in rows and columns. For example, the plurality of light sources may be arranged to form an approximate square by four adjacent light sources. In addition, any one light source is disposed adjacent to four light sources, and a distance between the single light source and each of the four light sources adjacent to the single light source may be substantially the same.

Furthermore, according to one or more embodiments, the plurality of light sources may be arranged such that three adjacent light sources form a substantially equilateral triangle. In this case, a single light source may be disposed adjacent to six light sources. In addition, a distance between the single light source and each of the six adjacent light sources may be substantially the same.

However, the arrangement in which the plurality of light emitters 111 are disposed is not limited to the arrangement described above, and the plurality of light emitters 111 may be disposed in various patterns to allow light to be emitted with uniform luminance.

Each light emitter 111 may employ a device capable of emitting monochromatic light (light having a specific range of wavelengths, for example, blue light) or white light (for example, mixed light of red light, green light, and blue light) in various directions when power is supplied. For example, the light emitter 111 may include a light-emitting diode (LED). The LED may be implemented in a variety of sizes and may include, for example, mini LEDs and/or micro LEDs.

The substrate 112 may fix the plurality of light emitters 111 to prevent positions of the light emitters 111 from being changed. In addition, the substrate 112 may supply power for enabling the light emitters 111 to emit light to the individual light emitters 111.

The substrate 112 may fix the plurality of light emitters 111, and may include a synthetic resin and/or tempered glass and/or a printed circuit board (PCB) on which a conductive power feed line for supplying power to the light emitter 111 is formed.

The reflector sheet 120 may reflect light emitted from the plurality of light emitters 111 in a forward direction or in a direction close to the forward direction.

A plurality of through holes 120a corresponding respectively to the plurality of light emitters 111 of the light source module 110 are formed in the reflector sheet 120. In addition, the light emitters 111 of the light source module 110 may pass through the through holes 120a and protrude forward of the reflector sheet 120.

For example, in an assembly process of the reflector sheet 120 and the light source module 110, the plurality of light emitters 111 of the light source module 110 are inserted into the plurality of through holes 120a formed in the reflector sheet 120. As a result, the substrate 112 of the light source module 110 is located behind the reflector sheet 120, but the plurality of light emitters 111 of the light source module 110 may be located in front of the reflector sheet 120.

Accordingly, the plurality of light emitters 111 may emit light in front of the reflector sheet 120.

The plurality of light emitters 111 may emit light in front of the reflector sheet 120 in various directions. Light may be emitted from the light emitter 111 not only toward the diffuser plate 130, but also toward the reflector sheet 120, and the reflector sheet 120 may reflect the light emitted toward the reflector sheet 120 toward the diffuser plate 130.

The light emitted from the light emitter 111 passes through various objects such as the diffuser plate 130 and the optical sheet 140. When the light passes the diffuser plate 130 and the optical sheet 140, a portion of the incident light is reflected from surfaces of the diffuser plate 130 and the optical sheet 140. The reflector sheet 120 may reflect the light reflected by the diffuser plate 130 and the optical sheet 140.

The diffuser plate 130 may be disposed in front of the light source module 110 and the reflector sheet 120, and may uniformly disperse the light emitted from the light emitter 111 of the light source module 110.

As described above, the plurality of light emitters 111 are located at various positions on a rear surface of the backlight unit 100. Although the plurality of light emitters 111 are equidistantly arranged on the rear surface of the backlight unit 100, non-uniformity of luminance may exist depending on the positions of the plurality of light emitters 111.

To eliminate the non-uniformity of luminance due to the plurality of light emitters 111, the diffuser plate 130 may diffuse the light emitted from the plurality of light emitters 111 within the diffuser plate 130. In other words, the diffuser plate 130 may uniformly emit non-uniform light from the plurality of light emitters 111 to the front surface.

The optical sheet 140 may include various sheets for improving luminance and luminance uniformity. For example, the optical sheet 140 may include a diffuser sheet 141, a first prism sheet 142, a second prism sheet 143, a reflective polarizing sheet 144, and the like.

The diffuser sheet 141 diffuses light for uniformity of luminance. The light emitted from the light emitter 111 is diffused by the diffuser plate 130, and may be diffused again by the diffuser sheet 141 included in the optical sheet 140.

The first and second prism sheets 142 and 143 may concentrate the light diffused by the diffuser sheet 141, thereby increasing the luminance. The first and second prism sheets 142 and 143 include a prism pattern of a triangular prism shape, and a plurality of these prism patterns are arranged adjacent to each other to form a plurality of bands.

The reflective polarizing sheet 144 is a kind of polarizing film, and may transmit a portion of the incident light, and reflect other portions to improve luminance. For example, the reflective polarizing sheet 144 may transmit light polarized in the same direction as a predetermined polarization direction of the reflective polarizing sheet 144 and reflect light polarized in a different direction from the polarization direction of the reflective polarizing sheet 144. In addition, the light reflected by the reflective polarizing sheet 144 is reused within the backlight unit 100, and the luminance of the display apparatus 10 may be improved by such light recycle.

The optical sheet 140 is not limited to the sheets or films shown in FIG. 4, and may further include more various sheets or films such as protective sheets.

The backlight unit 100 includes the plurality of light emitters (or light sources) 111, and may output surface light by diffusing the light emitted from the plurality of light sources 111. The liquid crystal panel 20 includes a plurality of pixels, and may control the plurality of pixels to allow each of the plurality of pixels to transmit or block light. An image may be formed by light passing through each of the plurality of pixels.

In this instance, the display apparatus 10 may perform local dimming to vary a brightness of light for each region of the backlight unit 100 in association with the output image to improve power consumption while increasing a contrast ratio.

For example, the display apparatus 10 may reduce the brightness of light of the light emitter 111 of the backlight unit 100 corresponding to a dark portion of an image to make the dark portion of the image darker, and may increase the brightness of light of the light emitter 111 of the backlight unit 100 corresponding to a bright portion of the image to make the bright portion of the image brighter. As a result, a contrast ratio or a brightness ratio of the image may be improved.

The display apparatus 10 may divide the backlight unit 100 into a plurality of blocks, and adjust current independently for each block according to an input image. Image transmission of the display apparatus 10 is performed through a method of frame-by-frame local dimming drives, and the driving of the current is adjusted according to the number of divided blocks of the light emitters 111 in the backlight unit 100.

As a result, the display apparatus 10 may effectively improve a contrast ratio by lowering a supply current to the dimming blocks of regions where the input image is dark and increasing the supply current to the dimming blocks of regions where the input image is bright.

For local dimming, the plurality of light emitters 111 included in the backlight unit 100 may be divided into a plurality of dimming blocks 200. For example, the plurality of dimming blocks 200 may be provided as a total of 60 blocks, composed of five rows and twelve columns, as shown in FIG. 5. As another example, the plurality of dimming blocks 200 may be provided as a total of 20 blocks, composed of five rows and four columns. However, the number of dimming blocks 200 is not limited to the above examples.

Referring to FIG. 5, each of the plurality of dimming blocks 200 may include at least one light emitter 111. The backlight unit 100 may supply the same driving current to the light emitters 111 belonging to the same dimming block 200, and the light emitters 111 belonging to the same dimming block 200 may emit light of the same brightness.

In addition, the backlight unit 100 may supply different driving currents to the light emitters 111 belonging to different dimming blocks 200 according to dimming data, and the light emitters 111 belonging to different dimming blocks 200 may emit light of different brightness.

As will be described below, among the light emitters 111 belonging to the same dimming block 200, different driving currents may be supplied to LEDs that output light of different colors, and the same driving current may be supplied to LEDs that output light of the same color. To this end, dimming data corresponding to one dimming block may include an RGB color value.

For example, each of the plurality of dimming blocks 200 may include N*M light sources arranged in an N*M matrix form (N and M are natural numbers). The N*M matrix refers to a matrix with N rows and M columns.

Because each of the light emitters 111 includes an LED, each of the plurality of dimming blocks 200 may include N*M LEDs. That is, each of the plurality of dimming blocks 200 may include a predetermined number of light emitters 111.

The plurality of dimming blocks 200 may be disposed on the substrate 112. That is, N*M LEDs may be disposed on the substrate 112.

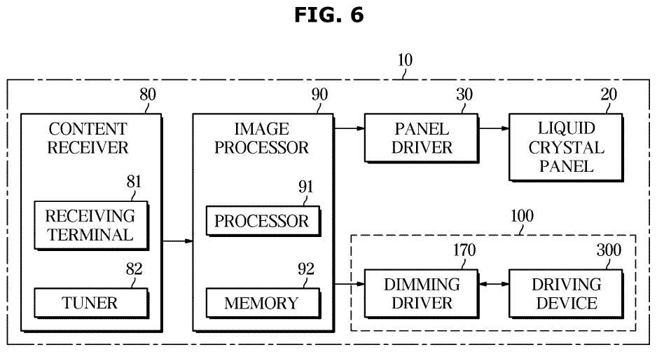

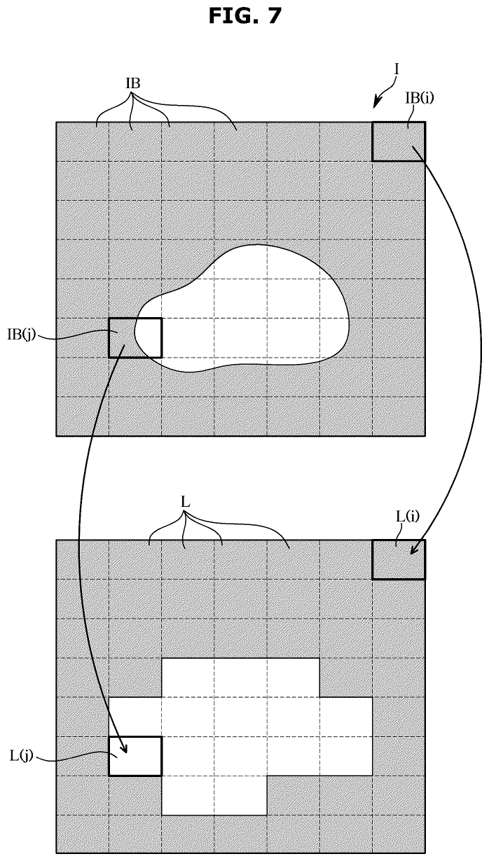

FIG. 6 is a control block diagram of a display apparatus according to one or more embodiments, and FIG. 7 illustrates an example in which a display apparatus converts image data into dimming data according to one or more embodiments.

Referring to FIG. 6, the display apparatus 10 may include a content receiver 80, an image processor 90, the panel driver 30, the liquid crystal panel 20, and the backlight unit 100. In one or more embodiments, the backlight unit 100 may include a dimming driver 170 that performs local dimming and a driving device 300 that drives the light emitter 111. The driving device 300 may be disposed on an upper surface or a lower surface of the substrate 112.

The content receiver 80 may include a receiving terminal 81 receiving content including a video signal and/or audio signal from content sources, and a tuner 82.

The receiving terminal 81 may receive a video signal and audio signal from content sources through a cable. For example, the receiving terminal 81 may include a component (YPbPr/RGB) terminal, a composite video blanking and sync (CVBS) terminal, an audio terminal, a high definition multimedia interface (HDMI) terminal, a universal serial bus (USB) terminal, and the like.

The tuner 82 may receive a broadcast signal from a broadcast reception antenna or a wired cable, and may extract a broadcast signal of a channel selected by a user from among broadcast signals. For example, the tuner 82 may pass a broadcast signal having a frequency corresponding to the channel selected by the user among a plurality of broadcast signals received through the broadcast reception antenna or wired cable, and may block a broadcast signal having a different frequency.

As described above, the content receiver 80 may receive an image including a video signal and an audio signal from the content sources through the receiving terminal 81 and/or the tuner 82, and may output the input image received through the receiving terminal 81 and/or the tuner 82 to the image processor 90.

The image processor 90 may include at least one processor 91 that processes an input image (image data) and a memory 92 that records/stores data.

The memory 92 stores programs and data for processing a video signal and/or an audio signal, and may temporarily remember data generated while processing the video signal and/or audio signal.

The memory 92 may include a non-volatile memory, such as read only memory (ROM) and flash memory, and a volatile memory, such as static random access memory (S-RAM) and dynamic random access memory (D-RAM).

The at least one processor 91 may receive an input image including a video signal and/or an audio signal from the content receiver 80, may decode the video signal into image data, and may generate dimming data from the image data. The image data and the dimming data may be output to the panel driver 30 and the dimming driver 170, respectively.

The at least one processor 91 may provide dimming data for local dimming to the backlight unit 100. The dimming data may include information about a luminance of each of the plurality of dimming blocks 200. For example, the dimming data may include information about an intensity of light output by the light emitters 111 included in each of the plurality of dimming blocks 200. That is, the dimming data may include information about a magnitude of current supplied to the light emitters 111 included in each of the plurality of dimming blocks 200.

The dimming data may include information about a magnitude of current supplied to each of a red LED, a green LED, and a blue LED included in the light emitter 111 included in each of the plurality of dimming blocks 200.

The at least one processor 91 may calculate an average of RGB color values of each of the plurality of dimming blocks 200 based on the image data, and may generate dimming data of each of the plurality of dimming blocks 200 based on the average of the RGB color values.

The at least one processor 91 may obtain the dimming data from the image data decoded from the video signal.

The processor 91 may convert the image data into the dimming data in various manners. For example, as shown in FIG. 7, the processor 91 may divide an image I based on the image data into a plurality of image blocks IB. The number of the plurality of image blocks IB is equal to the number of the plurality of dimming blocks 200, and the plurality of image blocks IB may each correspond to the plurality of dimming blocks 200.

The processor 91 may obtain luminance values L of the plurality of dimming blocks 200 from the image data of the plurality of image blocks IB. The luminance value L of each of the plurality of dimming blocks 200 may include an RGB color value of each of the plurality of dimming blocks 200.

The processor 91 may generate the dimming data by combining the luminance values L of the plurality of dimming blocks 200.

For example, the processor 91 may obtain a luminance value L of each of the plurality of dimming blocks 200 based on a maximum value among luminance values of pixels included in each of the image blocks IB.

A single image block includes a plurality of pixels, and image data of a single image block may include image data of a plurality of pixels (e.g., red data, green data, blue data, etc.). The processor 91 may calculate the luminance value of each of the pixels based on the image data of each of the pixels.

The processor 91 may determine a maximum value of the luminance values of pixels included in an image block as a luminance value of a dimming block corresponding to the image block. For example, the processor 91 may determine a maximum value of luminance values of pixels included in the i-th image block IB(i) as a luminance value L(i) of an i-th dimming block, and may determine a maximum value of luminance values of pixels included in a j-th image block IB(j) as a luminance value L(j) of a j-th dimming block.

The processor 91 may generate dimming data by combining the luminance values of the plurality of dimming blocks 200.

As such, the image processor 90 may decode the video signal obtained by the content receiver 80 into image data, and may generate the dimming data from the image data. In addition, the image processor 90 may transmit the image data and the dimming data to the liquid crystal panel 20 and the light source apparatus 100, respectively.

The liquid crystal panel 20 includes a plurality of pixels capable of transmitting or blocking light, and the plurality of pixels are arranged in a matrix form. In other words, the plurality of pixels may be arranged in a plurality of rows and a plurality of columns.

The panel driver 30 may receive the image data from the image processor 90 and drive the liquid crystal panel 20 according to the image data. In other words, the panel driver 30 may convert image data, which is a digital signal (hereinafter, referred to as ‘digital image data’), into an analog image signal, which is an analog voltage signal, and may provide the converted analog image signal to the liquid crystal panel 20. Optical properties (e.g., light transmittance) of the plurality of pixels included in the liquid crystal panel 20 may change according to the analog image signal.

The panel driver 30 may include, for example, a timing controller, a data driver, a scan driver, and the like.

The timing controller may receive image data from the image processor 90 and output the image data and a drive control signal to the data driver and the scan driver. The drive control signal may include a scan control signal and a data control signal, and the scan control signal and the data control signal may be used to control operations of the scan driver and the data driver, respectively.

The scan driver may receive a scan control signal from the timing controller, and may input-activate any one of the plurality of rows in the liquid crystal panel 20 according to the scan control signal. In other words, the scan driver may convert pixels, included in a single row among the plurality of pixels arranged in the plurality of rows and the plurality of columns, into a state capable of receiving an analog image signal. In this instance, the other pixels input-deactivated, except for the pixels input-activated by the scan driver, may not receive an analog image signal.

The data driver may receive image data and a data control signal from the timing controller and output the image data to the liquid crystal panel 20 according to the data control signal. For example, the data driver may receive the digital image data from the timing controller and convert the digital image data into an analog image signal. In addition, the data driver may provide the analog image signal to pixels included in any one row input-activated by the scan driver. In this instance, the pixels input-activated by the scan driver receive the analog image signal, and optical properties (e.g., light transmittance) of the input-activated pixels may change according to the received analog image signal.

As described above, the panel driver 30 may drive the liquid crystal panel 20 according to image data. As a result, an image corresponding to the image data may be displayed on the liquid crystal panel 20.

The light source apparatus 100 includes a plurality of light sources 111 that emit light, and the plurality of light sources 111 are arranged in a matrix form. In other words, the plurality of light sources 111 may be arranged in a plurality of rows and a plurality of columns. In addition, the light source apparatus 100 may be divided into a plurality of dimming blocks 200, and each of the plurality of dimming blocks 200 may include at least one light source.

The dimming driver 170 may receive dimming data from the image processor 90 and drive the light source apparatus 100 according to the dimming data. Here, the dimming data may include information about a luminance of each of the plurality of dimming blocks 200 or information about a brightness of the light sources included in each of the plurality of dimming blocks 200.

The dimming driver 170 may convert the dimming data, which is a digital signal, into an analog dimming signal, which is an analog voltage signal, and may provide the analog dimming signal to the light source apparatus 100. According to the analog dimming signal, an intensity of light emitted by the light sources included in each of the plurality of dimming blocks 200 may change.

In particular, the dimming driver 170 may provide the analog dimming signal sequentially to the plurality of dimming blocks 200 by an active matrix method, instead of directly providing the analog dimming signal to all of the plurality of dimming blocks 200.

As described above, the plurality of dimming blocks 200 may be arranged in a matrix form in the light source apparatus 100. In other words, the plurality of dimming blocks 200 may be arranged in a plurality of rows and a plurality of columns in the light source apparatus 100.

The dimming driver 170 may provide the analog dimming signal sequentially to dimming blocks belonging to each of the plurality of rows or to dimming blocks belonging to each of the plurality of columns.

For example, the dimming driver 170 may input-activate dimming blocks belonging to any one row of the plurality of dimming blocks 200, and may provide the analog dimming signal to the input-activated dimming blocks. Thereafter, the dimming driver 170 may input-activate dimming blocks belonging to another row of the plurality of dimming blocks 200, and may provide the analog dimming signal to the input-activated dimming blocks.

The dimming driver 170 may receive the dimming data from the image processor 90 and drive the driving device 300 according to the dimming data.

The driving device 300 may control at least one dimming block among the plurality of dimming blocks 200. The driving device 300 may control the dimming block 200 based on a control signal received from the dimming driver 170.

The driving device 300 may also be referred to as a driving integrated circuit (IC) or a pixel IC in that the driving device 300 is an integrated circuit for driving at least one dimming block among the plurality of dimming blocks 200.

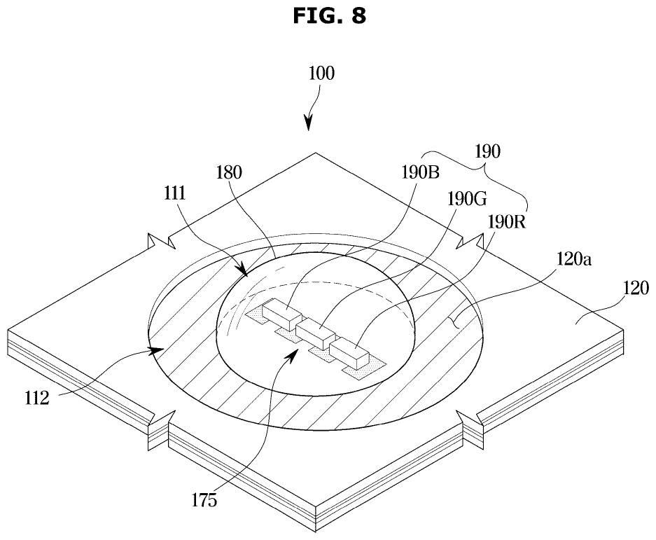

FIG. 8 illustrates an example of a light source included in a light source apparatus according to one or more embodiments.

Referring to FIG. 8, the light emitter 111 may include a red LED 190R, a green LED 190G, and a blue LED 190B.

The red LED 190R may include at least one red LED connected in series with each other. The green LED 190G may include at least one green LED connected in series with each other. The blue LED 190B may include at least one blue LED connected in series with each other.

In the disclosure, an anode of the LEDs 190R, 190G, and 190B may refer to an anode of a first LED whose anode is not connected to another LED among at least one LED connected in series with each other.

In the disclosure, a cathode of the LEDs 190R, 190G, and 190B may refer to a cathode of a last LED whose cathode is not connected to another LED among at least one LED connected in series with each other.

A plurality of LED groups 175 may be arranged in a two-dimensional matrix form on an upper surface of the substrate 112. That is, as shown in FIG. 4, because the plurality of light emitters 111 are arranged in rows and columns, the plurality of LED groups 175 may be arranged in a two-dimensional matrix form.

In addition, according to one or more embodiments, the plurality of light sources may be arranged such that three adjacent light sources form a substantially equilateral triangle. In this case, a single light source may be adjacent to six light sources. In addition, a distance between the single light source and each of the six adjacent light sources may be substantially the same.

However, the arrangement of the plurality of light emitters 111 is not limited to the arrangement described above, and the plurality of light emitters 111 may be arranged in various ways to emit light with uniform luminance.

The light emitter 111 may employ a device capable of emitting white light (e.g., light having a plurality of peak wavelengths, for example, mixed light of red light, green light, and blue light) in various directions when power is supplied.

That is, each light emitter 111 may emit white light by including the red LED 190R, the green LED 190G, and the blue LED 190B.

An intensity of red light emitted by the red LED 190R, an intensity of green light emitted by the green LED 190G, and an intensity of blue light emitted by the blue LED 190B may each be independently changed based on dimming data.

As shown in FIG. 8, each of the plurality of light emitters 111 may include an LED group 175 and an optical dome 180.

The backlight unit 100 may have a small thickness to allow the display apparatus 10 to have a small thickness. To reduce the thickness of the backlight unit 100, each of the plurality of light emitters 111 may have a small thickness and a simple structure.

Each LED included in each LED group 175 may include a P-type semiconductor and an N-type semiconductor to emit light by recombination of holes and electrons. In addition, the LED may include a pair of electrodes for supplying holes and electrons to the P-type semiconductor and the N-type semiconductor.

Each of the LEDs 190 (190R, 190G, and 190B) may be configured to convert electrical energy into light energy. Each of the LEDs 190R, 190G, and 190B may emit light having a maximum intensity in a predetermined wavelength based on the supplied power. For example, the blue LED 190B may emit blue light having a peak value in a wavelength (e.g., a wavelength ranging from 430 nm to 495 nm) that displays a blue color.

For example, a multilayer reflective structure in which a plurality of insulating films having different refractive indices are alternately laminated may be provided on a front surface of each of the LEDs 190R, 190G, and 190B. For example, the multilayer reflective structure may be configured as a distributed Bragg reflector (DBR). The DBR is a structure in which two or more materials having different refractive indices are alternately laminated, and may be an optical device that has high reflectivity for light of a specific wavelength according to a principle of forming an optical path difference according to a wavelength to induce strong reflection in a specific frequency band.

In addition, the LEDs 190R, 190G, and 190B of the LED group 175 may be directly attached to the substrate 112 by a chip on board (COB) method. For example, the light emitter 111 may include an LED 190 formed by attaching an LED chip or an LED die directly to the substrate 112 without separate packaging.

The LED 190 may be manufactured as a flip-chip type. The LED 190 of the flip chip type may be formed by welding, upon attaching an LED being a semiconductor device to the substrate 112, an electrode pattern of a semiconductor device as it is to the substrate 112 without using a middle medium, such as a metal lead (wire) or a ball grid array (BGA). As such, by using neither a metal lead (wire) nor a ball grid array, the light emitter 111 including the LED 190 of the flip chip type may be miniaturized.

Although the flip-chip type LED 190 welded directly to the substrate 112 by the chip on board method has been described above, the light emitter 111 is not limited to the flip-chip type LED. For example, the light emitter 111 may include a package-type LED.

The optical dome 180 may cover the LED group 175. That is, the optical dome 180 may cover the red LED 190R, the green LED 190G, and the blue LED 190B included in the LED group 175.

The optical dome 180 may refract red light, green light, and blue light respectively emitted from the red LED 190R, the green LED 190G, and the blue LED 190B to mix the red light, green light, and blue light, thereby emitting white light.

As such, the optical dome 180 may emit white light by mixing red light, green light, and blue light, and reduce a distance required for mixing to white light, compared to a case in which no optical dome 180 exists, thereby reducing an optical distance (OD) required for changing point light sources to a surface light source.

In addition, the optical dome 180 may prevent or suppress the LEDs 190 from being damaged by a mechanical action from outside and/or by a chemical action.

The optical dome 180 may be in a shape of a dome resulting from cutting, for example, a sphere with a plane not including a center of the sphere, or in a shape of a hemisphere resulting from cutting a sphere with a plane including a center of the sphere. A vertical section of the optical dome 180 may be in a shape of, for example, a segment of a circle or a semicircle.

The optical dome 180 may be formed of silicon or epoxy resin. For example, the optical dome 180 may be formed by discharging molten silicon or a molten epoxy resin onto the LEDs 190 through a nozzle, etc. and then hardening the silicon or epoxy resin.

The optical dome 180 may be optically transparent or translucent. Light emitted from the LED 190 may pass through the optical dome 180 and be emitted to the outside.

In this instance, the dome-shaped optical dome 180 may refract light, like a lens. For example, light emitted from the LEDs 190 may be refracted by the optical dome 180 and dispersed.

As such, the optical dome 180 may not only protect the LEDs 190 from external mechanical action and/or chemical action or electrical action, but also disperse light emitted from the LEDs 190.

Although the optical dome 180 in the form of a silicon dome has been described above, the light emitter 111 is not limited to including the optical dome 180. For example, the light emitter 111 may include a lens for dispersing light emitted from the LEDs.

As described above, according to the disclosure, because each light emitter 111 includes the red LED 190R, the green LED 190G, and the blue LED 190B, higher color purity, a higher contrast ratio, and higher image quality may be achieved in a local dimming operation than in local dimming using single light.

The embodiments to be described below may also be applied to a self-emissive display apparatus in which a display panel itself includes the light emitter 111 (e.g., the red LED 190R, the green LED 190G, and the blue LED 190B) without a separate backlight unit.

In the disclosure, in a case where the display apparatus 10 according to one or more embodiments includes the backlight unit 100, “image frame data” may refer to dimming data, and in a case where the display apparatus 10 according to one or more embodiments does not include the backlight unit 100, “image frame data” may refer to image data.

In the disclosure, image frame data may refer to data including a color value (e.g., an RGB color value) for the light emitter 111 (e.g., the red LED 190R, the green LED 190G, and the blue LED 190B).

In the disclosure, an RGB color value may include an R value corresponding to a luminance value of the red LED 190R, a G value corresponding to a luminance value of the green LED 190G, and a B value corresponding to a luminance value of the blue LED 190B.

Each of the R value, the G value, and the B value may have a data value (or luminance value) within a predetermined range (e.g., 0 to 255) corresponding to luminance.

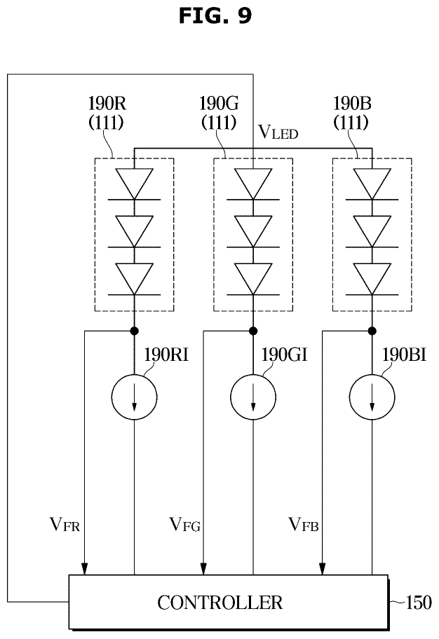

FIG. 9 illustrates a configuration for controlling a driving current flowing through a light emitter according to one or more embodiments.

Referring to FIG. 9, the display apparatus 10 may include a controller 150 for controlling a driving current flowing through the light emitter 111.

The controller 150 may include at least one processor and at least one memory for controlling the light emitter 111. The at least one processor of the controller 150 may perform various functions by individually or collectively executing computer executable instructions stored in the at least one memory.

The at least one memory may store various data (e.g., reference voltage data) required for controlling the light emitter 111.

The controller 150 may include at least one component for controlling the light emitter 111. For example, the controller 150 may include the image processor 90, the dimming driver 170, and/or the driving device 300.

The controller 150 may control the light emitter 111 based on image data.

Controlling the light emitter 111 based on image data may include generating dimming data based on the image data and controlling the light emitter 111 based on the dimming data.

As described above, image frame data may refer to either frame data included in the image data or frame data included in the dimming data.

Controlling the light emitter 111 based on the image data may include controlling the light emitter 111 based on the image frame data.

Controlling the light emitter 111 based on image frame data may include applying, to the light emitter 111, a driving current having a target amplitude corresponding to a color value included in the image frame data for a target application time corresponding to the color value included in the image frame data.

The target amplitude and the target application time corresponding to the color value may be pre-stored in the memory of the controller 150. The target amplitude and the target application time may be referred to as a “pulse amplitude modulation (PAM) control value” and a “pulse width modulation (PWM) control value”, respectively. The target amplitude may also be referred to as a target magnitude, a target intensity, or the like, and the target application time may also be referred to as a target driving time, a target on time, or the like.

Image data may include image frame data corresponding to a plurality of consecutive image frames. For example, the image data may include first image frame data corresponding to a first image frame, and second image frame data corresponding to a second image frame that follows the first image frame.

The second image frame may refer to a frame that immediately follows the first image frame, or may refer to a frame positioned a predetermined number of image frames after the first image frame.

The first and second image frame data may also be referred to as first and second dimming data, respectively.

The controller 150 may receive a feedback voltage detected at a cathode of the light emitter 111. For example, the controller 150 may receive a feedback voltage V_{FR} detected at a cathode of the red LED 190R. The controller 150 may receive a feedback voltage V_{FG} detected at a cathode of the green LED 190G. The controller 150 may receive a feedback voltage V_{FB} detected at a cathode of the blue LED 190B.

The controller 150 may include a sensing circuit for receiving the feedback voltage detected at the cathode of the light emitter 111.

Receiving, by the controller 150, the feedback voltage detected at the cathode of the light emitter 111 may include receiving information about a magnitude of the feedback voltage detected at the cathode of the light emitter 111.

The controller 150 may control a driving voltage V_{LED} applied to an anode of the light emitter 111. The controller 150 may control the driving voltage V_{LED} applied to the anode of the light emitter 111 based on image data. For example, the controller 150 may increase the driving voltage V_{LED} when the light emitter 111 requires to emit light of high luminance compared to when it requires to emit light of low luminance.

Although it is illustrated in FIG. 9 that the anodes of the red LED 190R, the green LED 190G, and the blue LED 190B each receive the same driving voltage V_{LED}, according to one or more embodiments, the anodes of the red LED 190R, the green LED 190G, and the blue LED 190B may receive different driving voltages.

The controller 150 may control a driving current flowing through the light emitter 111.

The controller 150 may operate in a sinking method that adjusts a cathode side current in a state where a driving voltage is applied to an anode of the light emitter 111. For example, a digital-to-analog converter (DAC) that converts a digital control signal into an analog current may be embedded in the driving device 300, which is a component of the controller 150, and the driving current flowing through the light emitter 111 may be controlled in a manner that the DAC supplies a required analog current to the light emitter 111 according to a digital input signal.

In one or more embodiments, the controller 150 may control the driving current flowing through the light emitter 111 using pulse width modulation (PWM) control and/or pulse amplitude modulation (PAM) control.

The controller 150 may control the driving current applied to the light emitter 111 based on image frame data.

For example, the controller 150 may control a driving current 190RI applied to the red LED 190R based on the image frame data. The controller 150 may control a driving current 190GI applied to the green LED 190G based on the image frame data. The controller 150 may control a driving current 190BI applied to the blue LED 190B based on the image frame data.

In one or more embodiments, in a first image frame, the controller 150 may control the driving current applied to the light emitter 111 based on first image frame data.

The first image frame data may refer to image data corresponding to the first image frame.

In one or more embodiments, in a second image frame following the first image frame, the controller 150 may control the driving current applied to the light emitter 111 based on second image frame data.

The second image frame data may refer to image data corresponding to the second image frame.

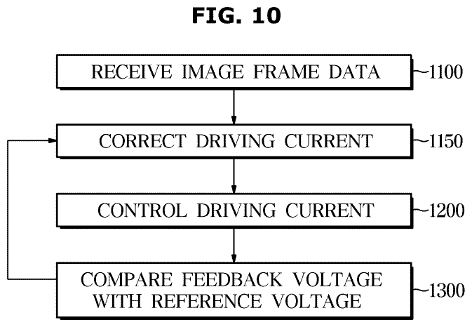

FIG. 10 is a flowchart illustrating an example method for controlling a display apparatus according to one or more embodiments.

Referring to FIG. 10, the controller 150 may receive image frame data (1100).

According to one or more embodiments, receiving the image frame data may include decoding a video signal received from the content receiver 80 into image data.

According to one or more embodiments, receiving the image frame data may include generating dimming data from the image data.

The flowchart shown in FIG. 10 illustrates operations that may be performed by the controller 150 in each image frame.

The controller 150 may correct (compensate, calibrate or adjust) a driving current, calculated based on image frame data corresponding to a current image frame, based on a comparison result of a feedback voltage and a reference voltage in a previous image frame (1150).

The controller 150 may control a driving current applied to the light emitter 111 based on the driving current corrected in operation 1150 (1200).

The controller 150 may compare a feedback voltage received in the current image frame with the reference voltage (1300), and may correct a driving current in a next image frame based on a comparison result of the feedback voltage and the reference voltage in the current image frame (1150).

In a first image frame, the controller 150 may receive first image frame data corresponding to the first image frame, and perform operations 1150, 1200, and 1300.

In a second image frame, the controller 150 may receive second image frame data corresponding to the second image frame, and perform operations 1150, 1200, and 1300.

In the first image frame, the controller 150 may control the driving current applied to the light emitter 111 based on the first image frame data corresponding to the first image frame.

Controlling the driving current applied to the light emitter 111 based on the first image frame data may include controlling the driving current applied to the light emitter 111 based on the first image frame data and a comparison result of a reference voltage and a feedback voltage in an image frame before the first image frame.

In the first image frame, the controller 150 may receive a feedback voltage detected at a cathode of the light emitter 111.

In a second image frame following the first image frame, the controller 150 may control a driving current based on second image frame data corresponding to the second image frame and a voltage difference between a feedback voltage received in the first image frame and a reference voltage corresponding to the first image frame data.

In the second image frame, the controller 150 may receive a feedback voltage detected at a cathode of the light emitter 111.

In a third image frame following the second image frame, the controller 150 may control a driving current based on third image frame data corresponding to the third image frame and a voltage difference between a feedback voltage received in the second image frame and a reference voltage corresponding to the second image frame data.

The controller 150 may repeat the operations shown in FIG. 10, and may control a luminance of the light emitter 111 in consideration of a degree of deterioration of the light emitter 111 in consecutive image frames.

A method of controlling a driving current based on current image frame data corresponding to a current image frame and a voltage difference between a feedback voltage received in a previous frame and a reference voltage corresponding to previous frame data will be described in detail below.

In one or more embodiments, the controller 150 may correct a driving current by correcting current image frame data corresponding to a current image frame based on a voltage difference between a feedback voltage received in a previous frame and a reference voltage corresponding to previous frame data.

In one or more embodiments, the controller 150 may correct a driving current by adding an RGB color value corresponding to a voltage difference between a feedback voltage received in a previous frame and a reference voltage corresponding to previous frame data to an RGB color value based on current image frame data corresponding to a current image frame.

In a case where the light emitter 111 includes the red LED 190R, the green LED 190G, and the blue LED 190B, even when the red LED 190R, the green LED 190G, and the blue LED 190B are controlled based on the same image frame data, the driving current 190RI of the red LED 190R, the driving current 190GI of the green LED 190G, and the driving current 190BI of the blue LED 190B may differ from each other.

For example, even when image frame data includes the same R, G, and B values, the driving currents 190RI, 190GI, and 190BI required to emit light of the same luminance value from the red LED 190R, the green LED 190G, and the blue LED 190B may be different from each other.

As an example, the red LED 190R may require a driving current of 3 mA during the corresponding frame period to emit red light corresponding to a luminance value of 100, whereas the blue LED 190B may require a driving current of 2.5 mA during the corresponding frame period to emit blue light corresponding to a luminance value of 100, and the green LED 190G may require a driving current of 2 mA during the corresponding frame period to emit green light corresponding to a luminance value of 100.

As another example, image frame data may include the same R, G, and B values, and accordingly, the respective driving currents required to emit light of the same luminance value from the red LED 190R, the green LED 190G, and the blue LED 190B may be different from each other.

That is, the controller 150 may control the driving current applied to the red LED 190R based on the R value included in the image frame data, may control the driving current applied to the green LED 190G based on the G value included in the image frame data, and may control the driving current applied to the blue LED 190B based on the B value included in the image frame data.

In controlling the driving current applied to the light emitter 111 based on the image frame data, the controller 150 may confirm a voltage (a potential difference across the light emitter 111) applied to the light emitter 111 based on information stored in the memory.

For example, in a case where an R value included in the image frame data is 100, a voltage applied to the red LED 190R which is in a non-deteriorated normal state may be 5V.

In this case, when three red LEDs 190R are connected in series, all the red LEDs 190R are in a normal state, and a driving voltage applied to an anode of the red LED 190R is 20V, then 5V may remain at a cathode of the red LED 190R.

As another example, in a case where a G value included in the image frame data is 100, a voltage applied to the green LED 190G which is in a non-deteriorated normal state may be 4.8V.

In this case, when three green LEDs 190G are connected in series, all the green LEDs 190G are in a normal state, and a driving voltage applied to an anode of the green LED 190G is 20V, then 5.6V may remain at a cathode of the green LED 190G.

As still another example, in a case where a B value included in the image frame data is 100, a voltage applied to the blue LED 190B which is in a non-deteriorated normal state may be 4.8V.

The above-described reference voltage may be predefined as a voltage that should remain at a cathode of an LED based on a case where the LED is in a normal state.

Even when the same driving current is applied to the LEDs 190R, 190G, and 190B, a voltage applied to both ends of the LEDs 190R, 190G, and 190B decreases as the LEDs 190R, 190G, and 190B deteriorate.

That is, as the LEDs 190R, 190G, and 190B deteriorate, the feedback voltage becomes greater than the reference voltage.

On the other hand, in a case where the driving voltage V_{LED} is insufficient due to various causes, the feedback voltage becomes smaller than the reference voltage.

In other words, when the driving voltage V_{LED} is insufficient, the feedback voltage is less than the reference voltage.

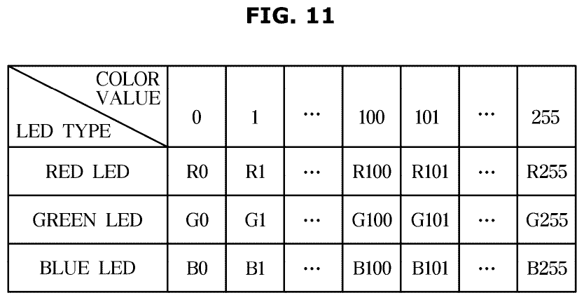

FIG. 11 illustrates reference voltages that vary for each type of LED and RGB color value according to one or more embodiments.

Referring to FIG. 11, the memory included in the controller 150 may store a lookup table in which a color value (or luminance value) and a reference voltage are matched according to the type of the LEDs 190R, 190G, and 190B.

For example, for the red LED 190R, the green LED 190G, and the blue LED 190B, reference voltages corresponding to a color value of 0 may be defined as R0, G0, and B0, respectively.

Similarly, for the red LED 190R, the green LED 190G, and the blue LED 190B, reference voltages corresponding to color values of 1, . . . , 100, 101, . . . ,255 may be defined as R1, G1, B1/R100, G100, B100/R101, G101, B101/R255, G255, B255, respectively.

A reference voltage associated with each of the red LED 190R, the green LED 190G, and the blue LED 190B corresponding to the same color value may be different depending on the type of LED. For example, R100, G100, and B100 may be different from each other.

In one or more embodiments, a reference voltage corresponding to image frame data may refer to a reference voltage corresponding to a color value of the image frame data.

For example, the reference voltage corresponding to the image frame data may include a first reference voltage corresponding to an R value of the image frame data, a second reference voltage corresponding to a G value of the image frame data, and a third reference voltage corresponding to a B value of the image frame data.

Due to material characteristics of the LED, even when the R, G, and B values are the same, at least some of the first reference voltage, the second reference voltage, and the third reference voltage may differ.

For example, in a case where the R value and the B value are equal, a magnitude of the first reference voltage may be different from that of the third reference voltage. For example, in a case where the R value and the B value are equal, the magnitude of the first reference voltage may be greater than that of the third reference voltage.

As another example, in a case where the R value and the G value are equal, a magnitude of the first reference voltage may be different from that of the second reference voltage. For example, in a case where the R value and the G value are equal, the magnitude of the second reference voltage may be greater than that of the first reference voltage.

As still another example, in a case where the G value and the B value are equal, a magnitude of the second reference voltage may be different from that of the third reference voltage. For example, in a case where the G value and the B value are equal, the magnitude of the second reference voltage may be greater than that of the third reference voltage.

According to the disclosure, the display apparatus 10 and a method of controlling the display apparatus 10 may identify deterioration characteristics of each of the red LED 190R, the green LED 190G, and the blue LED 190B and predefine different reference voltages for the same color value for each of the red LED 190R, the green LED 190G, and the blue LED 190B, thereby accurately reflecting a degree of deterioration of each of the red LED 190R, the green LED 190G, and the blue LED 190B to compensate for the degree of deterioration.

In the disclosure, ‘a reference voltage corresponding to image frame data’ may refer to a reference voltage corresponding to a color value. For example, the reference voltage corresponding to the image frame data may refer to a first reference voltage of the red LED 190R corresponding to an R value included in the image frame data, a second reference voltage of the green LED 190G corresponding to a G value included in the image frame data, and a third reference voltage of the blue LED 190B corresponding to a B value included in the image frame data.

Hereinafter, for convenience of description, it is assumed that the controller 150 controls the light emitter 111 in a second image frame that follows a first image frame.

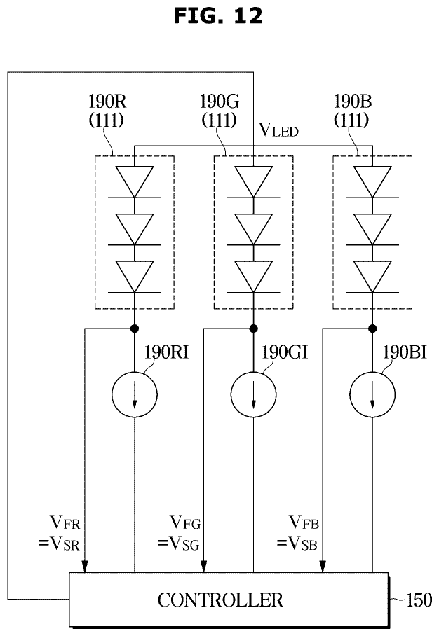

FIG. 12 illustrates a state in which LEDs are not deteriorated according to one or more embodiments.

Referring to FIG. 12, the controller 150 may determine a voltage difference between each feedback voltage V_{FR}, V_{FG}, and V_{FB} detected in a first image frame and each reference voltage V_{SR}, V_{SG}, and V_{SB} corresponding to first image frame data.

Because the reference voltage is defined based on a case where the light emitter 111 is in a normal state, it is estimated that the light emitter 111 is not deteriorated when the feedback voltage detected in the first image frame is equal to the reference voltage corresponding to the first image frame data.

In the disclosure, the feedback voltage and the reference voltage being equal to each other may include a voltage difference between the feedback voltage and the reference voltage being within a predetermined range (e.g., 0.1V).

Based on the feedback voltage detected in the first image frame being equal to the reference voltage corresponding to the first image frame data, the controller 150 may apply, to the light emitter 111, a driving current having a target amplitude corresponding to a color value included in second image frame data for a target application time corresponding to the color value included in the second image frame data.

In one or more embodiments, when correcting a driving current is not required, the controller 150 may perform only PAM control to control the driving current. For example, when correcting a driving current is not required, the controller 150 may apply a driving current having a target amplitude corresponding to a color value included in image frame data corresponding to the corresponding image frame for the entire period of time of the corresponding image frame.

That is, the controller 150 may not correct the second image frame data, based on the feedback voltage detected in the first image frame being equal to the reference voltage corresponding to the first image frame data.

For example, based on the feedback voltage V_{FR} detected at a cathode of the red LED 190R in the first image frame being equal to the reference voltage V_{SR} of the red LED 190R corresponding to the first image frame data, the controller 150 may apply, to the red LED 190R, a driving current having a target amplitude corresponding to an R value included in the second image frame data for a target application time corresponding to the R value included in the second image frame data. Based on the feedback voltage V_{FG} detected at a cathode of the green LED 190G in the first image frame being equal to the reference voltage V_{SG} of the green LED 190G corresponding to the first image frame data, the controller 150 may apply, to the green LED 190G, a driving current having a target amplitude corresponding to a G value included in the second image frame data for a target application time corresponding to the G value included in the second image frame data. Based on the feedback voltage V_{FB} detected at a cathode of the blue LED 190B in the first image frame being equal to the reference voltage V_{SB} of the blue LED 190B corresponding to the first image frame data, the controller 150 may apply, to the blue LED 190B, a driving current having a target amplitude corresponding to a B value included in the second image frame data for a target application time corresponding to the B value included in the second image frame data.

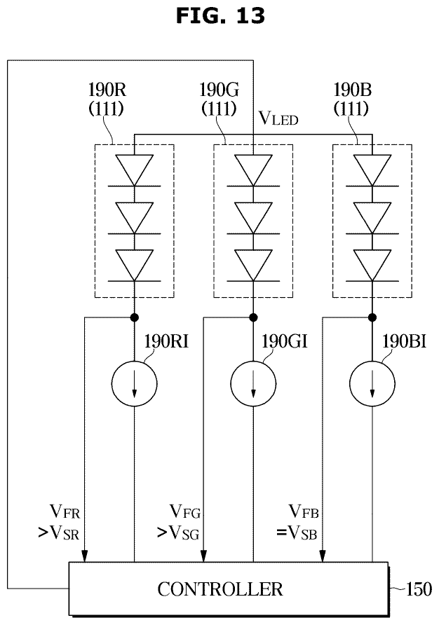

FIG. 13 illustrates a state in which a portion of LEDs are deteriorated according to one or more embodiments.

Referring to FIG. 13, the controller 150 may determine a voltage difference between each feedback voltage V_{FR}, V_{FG}, and V_{FB} detected in a first image frame and each reference voltage V_{SR}, V_{SG}, and V_{SB} corresponding to first image frame data.

Because the reference voltage is defined based on a case where the light emitter 111 is in a normal state, it is estimated that the light emitter 111 is deteriorated when the feedback voltage detected in the first image frame is greater than the reference voltage corresponding to the first image frame data.

In the disclosure, the feedback voltage being greater than the reference voltage may include the feedback voltage being greater than the reference voltage by a predetermined voltage (e.g., 0.1V) or more.

Based on the feedback voltage detected in the first image frame being greater than the reference voltage corresponding to the first image frame data, the controller 150 may apply, to the light emitter 111, a driving current having a target amplitude (hereinafter ‘second amplitude’) greater than a target amplitude (hereinafter ‘first amplitude’) corresponding to a color value included in second image frame data.

That is, the controller 150 may correct the second image frame data, based on the feedback voltage detected in the first image frame being greater than the reference voltage corresponding to the first image frame data.

A greater difference between the feedback voltage and the reference voltage may indicate more severe deterioration of the light emitter 111.

The controller 150 may determine the second amplitude based on the voltage difference between the feedback voltage and the reference voltage.

For example, the controller 150 may increase the second amplitude as the voltage difference between the feedback voltage and the reference voltage increases.

Based on the feedback voltage V_{FR} detected at a cathode of the red LED 190R in the first image frame being greater than the reference voltage V_{SR} of the red LED 190R corresponding to the first image frame data, the controller 150 may apply, to the red LED 190R, a driving current having a second amplitude greater than a first amplitude corresponding to an R value included in the second image frame data. Based on the feedback voltage V_{FG} detected at a cathode of the green LED 190G in the first image frame being greater than the reference voltage V_{SG} of the green LED 190G corresponding to the first image frame data, the controller 150 may apply, to the green LED 190G, a driving current having a second amplitude greater than a first amplitude corresponding to a G value included in the second image frame data. Based on the feedback voltage V_{FB} detected at a cathode of the blue LED 190B in the first image frame being greater than the reference voltage V_{SB} of the blue LED 190B corresponding to the first image frame data, the controller 150 may apply, to the blue LED 190B, a driving current having a second amplitude greater than a first amplitude corresponding to a B value included in the second image frame data.

When the light emitter 111 is deteriorated, applying a greater driving current to the light emitter 111 may correct the luminance, but cause more severe deterioration of the light emitter 111. As the degree of deterioration of the light emitter 111 increases, a greater driving current may be applied to the light emitter 111 in the next image frame. As a result, as the light emitter 111 deteriorates further, a cycle in which increased driving current causes further deterioration of the light emitter 111 may occur.

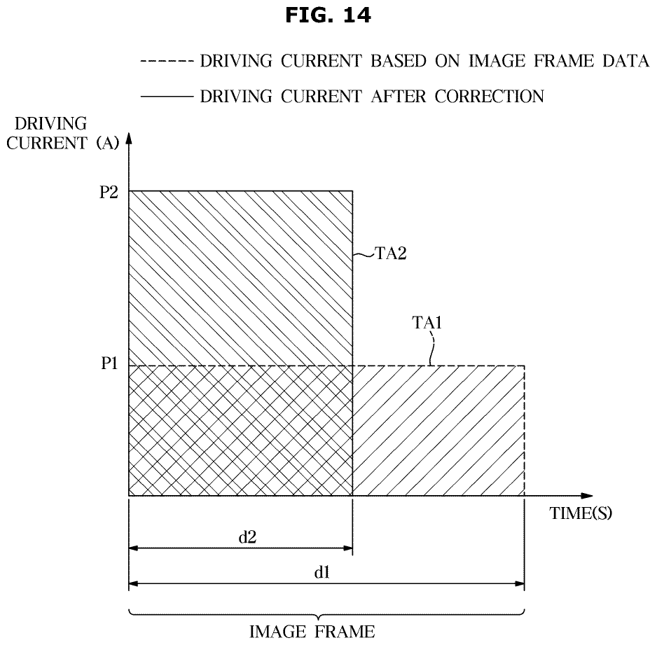

FIG. 14 illustrates an example of a driving current applied to an LED based on the same color value when the LED is deteriorated and when the LED is not deteriorated according to one or more embodiments.

Referring to FIG. 14, in an image frame, the controller 150 may adjust an amplitude and an application time of a driving current applied to the light emitter 111 through PWM control and PAM control.

In one or more embodiments, based on a feedback voltage detected in a first image frame being greater than a reference voltage corresponding to first image frame data, the controller 150 may apply, to the light emitter 111, a driving current having a second amplitude greater than a first amplitude corresponding to a color value included in second image frame data, but may reduce an application time of the driving current having the second amplitude.

In one or more embodiments, the controller 150 may apply, to the light emitter 111, a driving current having a second amplitude p2 for a target time (hereinafter ‘second application time d2’) shorter than a target application time (hereinafter ‘first application time d1’) corresponding to a color value included in the second image frame data.

That is, based on the feedback voltage detected in the first image frame being greater than the reference voltage corresponding to the first image frame data, the controller 150 may apply, to the light emitter 111, the driving current having the second amplitude p2 greater than the first amplitude p1 corresponding to the color value included in the second image frame data for the second application time d2 shorter than the first application time d1 corresponding to the color value included in the second image frame data.

However, a product TA1 of the first amplitude p1 and the first application time d1 may be less than a product TA2 of the second amplitude p2 and the second application time d2.

That is, the controller 150 may determine the second amplitude p2 and the second application time d2 such that the product TA2 of the second amplitude p2 and the second application time d2 is greater than the product TA1 of the first amplitude p1 and the first application time d1.

When the driving current is applied to the light emitter 111 for the second application time d2, which is shorter than the first application time d1, a period during which the light emitter 111 does not emit light occurs for a difference (d2−d1) between the second application time d2 and the first application time d1.

According to the disclosure, a time during which the light emitter 111 does not emit light within the corresponding image frame may be secured, thereby suppressing deterioration of the light emitter 111.

That is, according to the disclosure, sufficient time may be secured to compensate for luminance reduction due to deterioration of the light emitter 111 and recover from the deterioration of the light emitter 111.

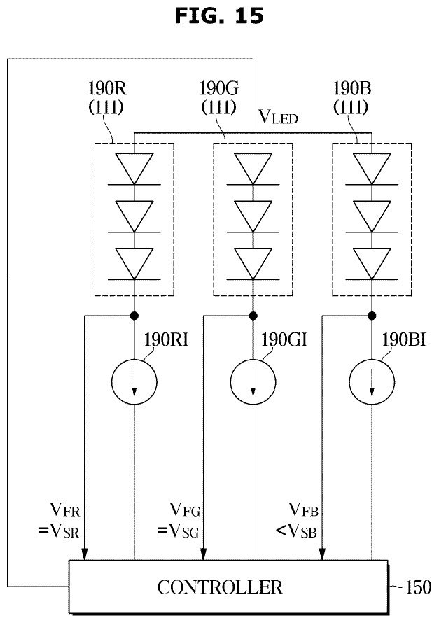

FIG. 15 illustrates a state in which a driving voltage applied to LEDs is insufficient according to one or more embodiments.

Referring to FIG. 15, the controller 150 may determine a voltage difference between each feedback voltage V_{FR}, V_{FG}, and V_{FB} detected in a first image frame and each reference voltage V_{SR}, V_{SG}, and V_{SB} corresponding to first image frame data.

Because the reference voltage is defined based on a case where the light emitter 111 is in a normal state, it is estimated that a driving voltage V_{LED} is insufficient when the feedback voltage detected in the first image frame is less than the reference voltage corresponding to the first image frame data.

In the disclosure, the feedback voltage being less than the reference voltage may include the feedback voltage being less than the reference voltage by a predetermined voltage (e.g., 0.1V) or less.

Based on the feedback voltage detected in the first image frame being less than the reference voltage corresponding to the first image frame data, the controller 150 may increase the driving voltage applied to an anode of the light emitter 111.

In a case where anodes of the red LED 190R, the green LED 190G, and the blue LED 190B are all connected to the same node and receive a driving voltage, the controller 150 may increase the driving voltage V_{LED} based on the feedback voltage V_{FR} detected at a cathode of the red LED 190R in the first image frame being less than the reference voltage V_{SR} of the red LED 190R corresponding to the first image frame data, or the feedback voltage V_{FG} detected at a cathode of the green LED 190G in the first image frame being less than the reference voltage V_{SG} of the green LED 190G corresponding to the first image frame data, or the feedback voltage V_{FB} detected at a cathode of the blue LED 190B in the first image frame being less than the reference voltage V_{SB} of the blue LED 190B corresponding to the first image frame data.

In a case where anodes of the red LED 190R, the green LED 190G, and the blue LED 190B are all connected to different nodes and independently receive a driving voltage, the controller 150 may increase a driving voltage V_{LED} applied to the anode of the red LED 190R based on the feedback voltage V_{FR} detected at a cathode of the red LED 190R in the first image frame being less than the reference voltage V_{SR} of the red LED 190R corresponding to the first image frame data, may increase a driving voltage V_{LED} applied to the anode of the green LED 190G based on the feedback voltage V_{FG} detected at a cathode of the green LED 190G in the first image frame being less than the reference voltage V_{SG} of the green LED 190G corresponding to the first image frame data, and may increase a driving voltage V_{LED} applied to the anode of the blue LED 190B based on the feedback voltage V_{FB} detected at a cathode of the blue LED 190B in the first image frame being less than the reference voltage V_{SB} of the blue LED 190B corresponding to the first image frame data.

According to the disclosure, when a driving voltage is not properly applied due to various causes, luminance reduction of the light emitter 111 may be prevented by increasing the driving voltage.

According to one or more embodiments of the disclosure, a display apparatus 10 may include: a light emitter 111; and a controller 150 configured to: in a first image frame, control a driving current applied to the light emitter 111 based on first image frame data corresponding to the first image frame, in the first image frame, receive a feedback voltage detected at a cathode of the light emitter 111, and in a second image frame following the first image frame, control the driving current based on second image frame data corresponding to the second image frame and a voltage difference between the feedback voltage and a reference voltage corresponding to the first image frame data.

In the second image frame, the controller 150 may be configured to apply, to the light emitter 111, the driving current having a second amplitude greater than a first amplitude corresponding to the second image frame data, based on the feedback voltage being greater than the reference voltage.

The controller 150 may be configured to determine the second amplitude based on the voltage difference.

In the second image frame, the controller 150 may be configured to apply the driving current to the light emitter 111 for a second application time shorter than a first application time corresponding to the second image frame data, based on the feedback voltage being greater than the reference voltage.

The controller 150 may be configured to determine the second amplitude and the second application time to allow a product of the second amplitude and the second application time to be greater than a product of the first amplitude and the first application time.

In the second image frame, the controller 150 may be configured to apply the driving current having the first amplitude to the light emitter 111 for the first application time, based on the feedback voltage being equal to the reference voltage.

In the second image frame, the controller 150 may be configured to increase a driving current applied to an anode of the light emitter 111, based on the feedback voltage being less than the reference voltage.

The light emitter 111 may include a red LED 190R that outputs red light, a green LED 190G that outputs green light, and a blue LED 190B that outputs blue light.

The first image frame data may include an R value which is a color value of the red LED 190R, a G value which is a color value of the green LED 190G, and a B value which is a color value of the blue LED 190B.

The reference voltage corresponding to the first image frame data may include a first reference voltage corresponding to the R value of the first image frame data, a second reference voltage corresponding to the G value of the first image frame data, and a third reference voltage corresponding to the B value of the first image frame data.

A magnitude of the first reference voltage may be greater than a magnitude of the third reference voltage, in response to the R value being equal to the B value.

A magnitude of the second reference voltage may be greater than a magnitude of the first reference voltage, in response to the R value being equal to the G value.

A magnitude of the second reference voltage may be greater than a magnitude of the third reference voltage, in response to the G value being equal to the B value.

According to one or more embodiments of the disclosure, a method for controlling a display apparatus 10 including a light emitter 111 may include: in a first image frame, controlling a driving current applied to the light emitter 111 based on first image frame data corresponding to the first image frame; in the first image frame, receiving a feedback voltage detected at a cathode of the light emitter 111; and in a second image frame following the first image frame, controlling the driving current based on second image frame data corresponding to the second image frame and a voltage difference between the feedback voltage and a reference voltage corresponding to the first image frame data.

The controlling of the driving current based on the second image frame data and the voltage difference may include applying, to the light emitter 111, the driving current having a second amplitude greater than a first amplitude corresponding to the second image frame data, based on the feedback voltage being greater than the reference voltage.

The method may further include determining the second amplitude based on the voltage difference.

The controlling of the driving current based on the second image frame data and the voltage difference may further include applying the driving current to the light emitter 111 for a second application time shorter than a first application time corresponding to the second image frame data, based on the feedback voltage being greater than the reference voltage.

The method may further include determining the second amplitude and the second application time to allow a product of the second amplitude and the second application time to be greater than a product of the first amplitude and the first application time.

The controlling of the driving current based on the second image frame data and the voltage difference may further include applying the driving current having the first amplitude to the light emitter 111 for the first application time, based on the feedback voltage being equal to the reference voltage.

The method may further include, in the second image frame, increasing a driving current applied to an anode of the light emitter 111, based on the feedback voltage being less than the reference voltage.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be a Read Only Memory (ROM), a Random Access Memory (RAM), a magnetic tape, a magnetic disk, a flash memory, an optical data storage device, etc.

Furthermore, the computer-readable recording medium may be provided in the form of a non-transitory storage medium. The term ‘non-transitory storage medium’ may refer to a tangible device without including a signal (e.g., electromagnetic waves) and may not distinguish between storing data in the storage medium semi-permanently and temporarily. For example, the non-transitory storage medium may include a buffer that temporarily stores data.

The method according to the one or more embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., play store™), directly between two user devices (e.g., smartphones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A display apparatus comprising:
a light emitter; and
a controller comprising memory storing instructions and at least one processor configured to execute the instructions,
wherein the instructions, when executed by the at least one processor individually or collectively, cause the display apparatus to:
in a first image frame, control a driving current applied to the light emitter based on first image frame data corresponding to the first image frame,
in the first image frame, receive a feedback voltage detected at a cathode of the light emitter, and
in a second image frame following the first image frame, control the driving current based on second image frame data corresponding to the second image frame and a voltage difference between the feedback voltage and a reference voltage corresponding to the first image frame data.

2. The display apparatus of claim 1, wherein the instructions, when executed by the at least one processor individually or collectively, further cause the display apparatus to, in the second image frame, cause the driving current to have a second amplitude greater than a first amplitude corresponding to the second image frame data, based on the feedback voltage being greater than the reference voltage.

3. The display apparatus of claim 2, wherein the instructions, when executed by the at least one processor individually or collectively, further cause the display apparatus to identify the second amplitude based on the voltage difference.

4. The display apparatus of claim 2, wherein the instructions, when executed by the at least one processor individually or collectively, further cause the display apparatus to, in the second image frame, apply the driving current to the light emitter for a second application time shorter than a first application time corresponding to the second image frame data, based on the feedback voltage being greater than the reference voltage.

5. The display apparatus of claim 4, wherein a product of the second amplitude and the second application time is greater than a product of the first amplitude and the first application time.

6. The display apparatus of claim 4, wherein the instructions, when executed by the at least one processor individually or collectively, further cause the display apparatus to, in the second image frame, cause the driving current to have the first amplitude for the first application time, based on the feedback voltage being equal to the reference voltage.

7. The display apparatus of claim 1, wherein, the instructions, when executed by the at least one processor individually or collectively, further cause the display apparatus to, in the second image frame, increase a driving current applied to an anode of the light emitter, based on the feedback voltage being less than the reference voltage.

8. The display apparatus of claim 1, wherein the light emitter comprises a red light-emitting diode (LED) configured to output red light, a green LED configured to output green light, and a blue LED configured to output blue light,
wherein the first image frame data comprises an R value which is a color value of the red LED, a G value which is a color value of the green LED, and a B value which is a color value of the blue LED, and
wherein the reference voltage corresponding to the first image frame data comprises a first reference voltage corresponding to the R value, a second reference voltage corresponding to the G value, and a third reference voltage corresponding to the B value.

9. The display apparatus of claim 8, wherein, based on the R value being equal to the B value, a magnitude of the first reference voltage is greater than a magnitude of the third reference voltage.

10. The display apparatus of claim 8, wherein, based on the R value being equal to the G value, a magnitude of the second reference voltage is greater than a magnitude of the first reference voltage.

11. A method of controlling a display apparatus, the method comprising:
in a first image frame, controlling a driving current applied to a light emitter of the display apparatus based on first image frame data corresponding to the first image frame;
in the first image frame, receiving a feedback voltage detected at a cathode of the light emitter; and
in a second image frame following the first image frame, controlling the driving current based on second image frame data corresponding to the second image frame and a voltage difference between the feedback voltage and a reference voltage corresponding to the first image frame data.

12. The method of claim 11, wherein the controlling the driving current based on the second image frame data and the voltage difference comprises causing the driving current to have a second amplitude greater than a first amplitude corresponding to the second image frame data, based on the feedback voltage being greater than the reference voltage.

13. The method of claim 12, further comprising:
identifying the second amplitude based on the voltage difference.

14. The method of claim 12, wherein the controlling the driving current based on the second image frame data and the voltage difference further comprises applying the driving current to the light emitter for a second application time shorter than a first application time corresponding to the second image frame data, based on the feedback voltage being greater than the reference voltage.

15. The method of claim 14, wherein a product of the second amplitude and the second application time is greater than a product of the first amplitude and the first application time.

16. A non-transitory computer readable medium having instructions stored therein, which when executed by at least one processor cause the at least one processor to execute a method of controlling a display apparatus, the method comprising:
in a first image frame, controlling a driving current applied to a light emitter of the display apparatus based on first image frame data corresponding to the first image frame;
in the first image frame, receiving a feedback voltage detected at a cathode of the light emitter; and
in a second image frame following the first image frame, controlling the driving current based on second image frame data corresponding to the second image frame and a voltage difference between the feedback voltage and a reference voltage corresponding to the first image frame data.

17. The non-transitory computer readable medium of claim 16, wherein the controlling the driving current based on the second image frame data and the voltage difference comprises causing the driving current to have a second amplitude greater than a first amplitude corresponding to the second image frame data, based on the feedback voltage being greater than the reference voltage.

18. The non-transitory computer readable medium of claim 17, wherein the method further comprises:
identifying the second amplitude based on the voltage difference.

19. The non-transitory computer readable medium of claim 17, wherein the controlling the driving current based on the second image frame data and the voltage difference further comprises applying the driving current to the light emitter for a second application time shorter than a first application time corresponding to the second image frame data, based on the feedback voltage being greater than the reference voltage.

20. The non-transitory computer readable medium of claim 19, wherein a product of the second amplitude and the second application time is greater than a product of the first amplitude and the first application time.
